(19) United States
(12) Patent Application Publication
(10) Pub. No.: US 2020/0269630 A1
(43) Pub. Date: Aug. 27, 2020

(54) SYSTEM, METHOD, AND KIT FOR CREATING ART

(71) Applicant: Stanley Markman, (US)

(72) Inventor: Stanley Markman, Cliffside Park, NJ (US)

(73) Assignee: Stanley Markman, Cliffside Park, NJ (US)

(21) Appl. No.: 16/795,684

(22) Filed: Feb. 20, 2020

Related U.S. Application Data
(60) Provisional application No. 62/811,065, filed on Feb. 27, 2019.

(51) Int. Cl. B44C 1/10; B44C 5/02

(52) U.S. Cl. CPC B44C 1/105; B44C 5/02

(57) ABSTRACT

A system, method, and kit to convert an image from a source, such as a newspaper or magazine, into a form of art for display. Such images are enormous in quantity in everyday newspapers and magazines, so an individual has an enormous, though random, selection of art that appears in newspapers and magazines, daily or periodically. Since the source of the art is plentiful, and the system, method, and kit utilize relatively inexpensive materials and supplies, such created art will be substantially less expensive than comparable commercial retail art. The system, method, and kit may be easily used and understood by any individual including children.

### CROSS-REFERENCE TO RELATED APPLICATION

This application claims priority to U.S. Provisional Application No. 62/811,065, filed on Feb. 27, 2019, which is incorporated by reference in its entirety.

### FIELD

The present disclosure relates to the creation of art, and in particular to a system, method, and kit for creating art.

### BACKGROUND

Picturesque images are found in many sources, such as newspapers and magazines. Often, people would remove such images from their sources by simply ripping or cutting them out from their source, with no further processing. However, such images are displayed on material which may easily bend and crease, which ruins the aesthetic appeal of the images on the front of the material. Typically, the material may have thicknesses in the range of 0.00315 inches to 0.00374 inches, and so bending and creasing easily occur.

A need exists for a system, method, and kit for preventing images on materials from being bent or creased.

In addition, the owner of such images may view the images as artistic and worthy of being displayed, for example, in the owner's home. However, such images on thin materials are not easily mounted to a frame. In addition, such images often have print or other images on the reverse side of the desired image, and such thinness of the material may cause the reverse-side print or images to be visible through the thin material of the desired image; for example, if the thin material is mounted on a light-colored background material or if light is shone through the thin material having the desired image, as shown in FIG. 13.

An artistic need exists for a system, method, and kit for mounting a desired image while preventing any reverse-side print or images from being visible through the material.

Furthermore, the desired image may have print or other sub-images on the front side of the material alongside the desired image, and the owner may not wish to view such print or sub-images.

A need exists for a system, method, and kit for hiding or otherwise redacting print or other sub-images from a desired image.

Lastly, images that are cut from newspapers or magazines and pasted onto other materials tend to degrade over time. For example, such images will discolor and/or deform over time.

Therefore, a need exists for a system, method, and kit for preventing images cut from newspapers or magazines that will maintain their integrity over time.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention includes a system, method, and an assemblage of art materials hereafter referred to as a kit for converting an image from a source, such as a newspaper or magazine, into a form of art for display. Such images are enormous in quantity in everyday newspapers and magazines, so an individual has an enormous, though random, selection of art that appears in newspapers and magazines, daily or periodically.

Since the source of the art is plentiful, and the system, method, and kit disclosed herein utilize relatively inexpensive materials and supplies, such art is created without the expenditure of a great deal of money. In addition, the system, method, and kit may be easily used and understood by any individual including children.

In one embodiment, the present invention is a kit including: a writing instrument for outlining an image on an image source; a cutting device for cutting the outlined image from the image source; an adhesive; a mounting surface for receiving the adhesive, and for receiving the cut out image on the adhesive; and a smoothening device for smoothening the received image on the adhesive and on the mounting surface generating a mounted image. The writing instrument is a pencil. The cutting device includes scissors. The adhesive is a spray adhesive output from a spray can. The mounting surface is substantially dark in color, such as black. The mounting surface is composed of construction paper. The smoothening device is a roller. The kit further includes a non-water based acrylic substance, with the image including print, and the non-water based acrylic substance covers the print. The non-water based acrylic substance is a non-water based acrylic ink or paint. The kit further includes a frame for receiving the mounted image. A matte is disposed adjacent to the mounted image on the frame.

In another embodiment, the present invention is a method including outlining an image on an image source using a writing instrument; cutting the outlined image from the image source using a cutting device; applying adhesive to a mounting surface; applying the cut out image on the adhesive; and smoothening the received image on the adhesive and on the mounting surface using a smoothening device generating a mounted image. The method further includes applying a non-water based acrylic substance to print including in the image to cover the print. The non-water based acrylic substance is ink or paint. The method further includes mounting the mounting image in a frame. The method further includes mounting the mounting image to a matte.

In a further embodiment, the present invention is a system including means for outlining an image on an image source; means for cutting the outlined image from the image source; means for applying adhesive to a mounting surface; and means for smoothening the cut out image placed on the adhesive and on the mounting surface.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 illustrates an initial material having an image to be processed;

FIG. 2 illustrates the image to be mounted;

FIG. 3 illustrates a mounting surface including a piece of black construction paper which is sprayed with adhesive and to which the image is placed;

FIG. 4 illustrates a roller device used to compress the image against the construction paper;

FIG. 5 illustrates an optional trimming of the image from the background material;

FIG. 6 illustrates the trimmed image of FIG. 5;

FIG. 7 illustrates another image having print to be hidden by application of ink or paint;

FIG. 8 illustrates the image with the print having been hidden;

FIG. 9 illustrates other images that have been processed using the present invention mounted on a matte in a frame;

FIG. 10 is a flowchart of the method of the present invention;

FIG. 11 illustrates an image with print and/or images on its reverse side being visible due to light shining from behind the image; and

FIG. 12 illustrates a kit of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

The present invention includes a system, method, and kit for converting an image from a source, such as a newspaper or magazine, into a form of art for display. The image is manipulated so that the image, whether including pictures and/or drawings, can be transformed into a graphic art modality which can then be framed and optionally hung, for example, in a private abode for personal viewing. Such created graphic art also enhances the living quarters of an individual.

The system, method, and kit of the present invention also provide distributors of art, who supply art education and associated supplies to their customers, with information of the present invention to enable large swathes of the population interested in craft arts to have the knowledge and skill to provide their living quarters with aesthetic art which can be either hung on a wall or otherwise displayed in any other manner.

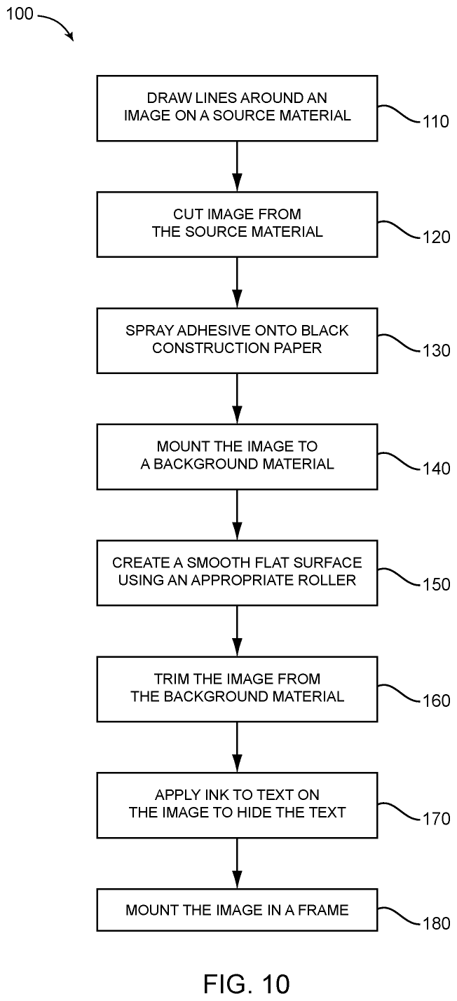

FIG. 10 is a flowchart of the method 100 of the present invention, which includes the steps of drawing lines around an image on a source material in step 110, cutting the image from the source material in step 120, spraying adhesive on construction paper in step 130, mounting the image on a background material in step 140, rolling the image to smoothen the surface in step 150, optionally trimming the image from the background material in step 160, optionally applying acrylic ink or acrylic fluid paint selectively to print and/or sub-images on the image to hide the print or sub-images in step 170, and optionally mounting the final image in a frame in step 180.

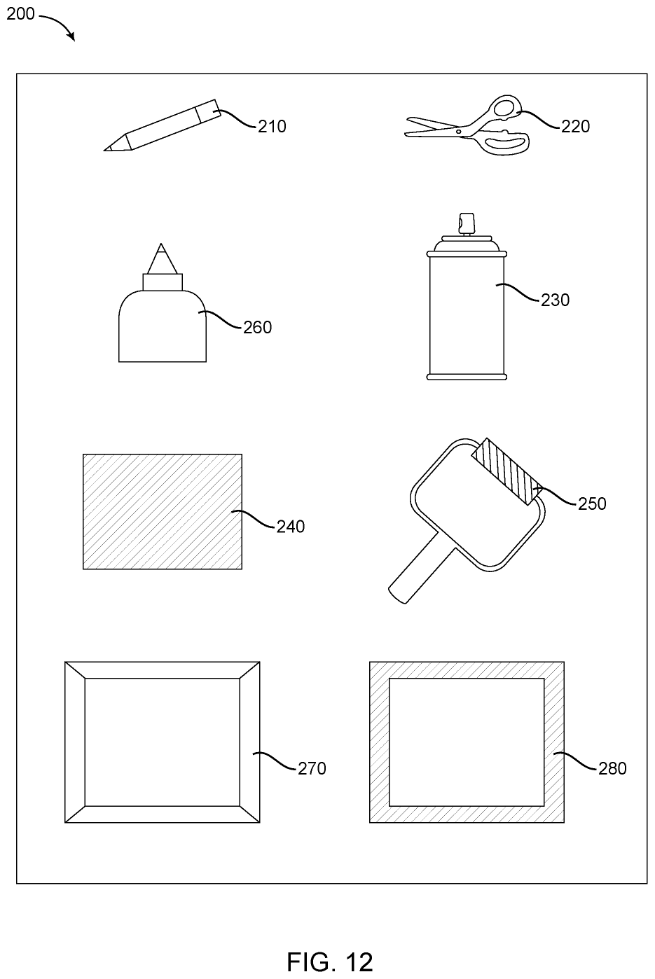

FIG. 12 is an example of a kit 200 of the present invention, which includes at least one of a writing instrument 210, a cutting device 220, an adhesive applied by an adhesive storage device 230, a mounting surface 240, a smoothening device 250, a non-water based acrylic substance applied by an acrylic substance dispenser 260, a frame 270, and a matte 280. In an example embodiment, the writing instrument 210 is a pencil; the cutting device 220 is scissors; the adhesive is a spray adhesive output from a spray can as the adhesive storage device 230; the mounting surface 240 is a piece of paper, such as construction paper, which is substantially dark in color or even black in color; the smoothening device 250 is a roller; the non-water based acrylic substance applied by an acrylic substance dispenser 260 is a non-water based acrylic ink or paint; and the matte 270 may be disposed adjacent to the mounted image on the frame 280.

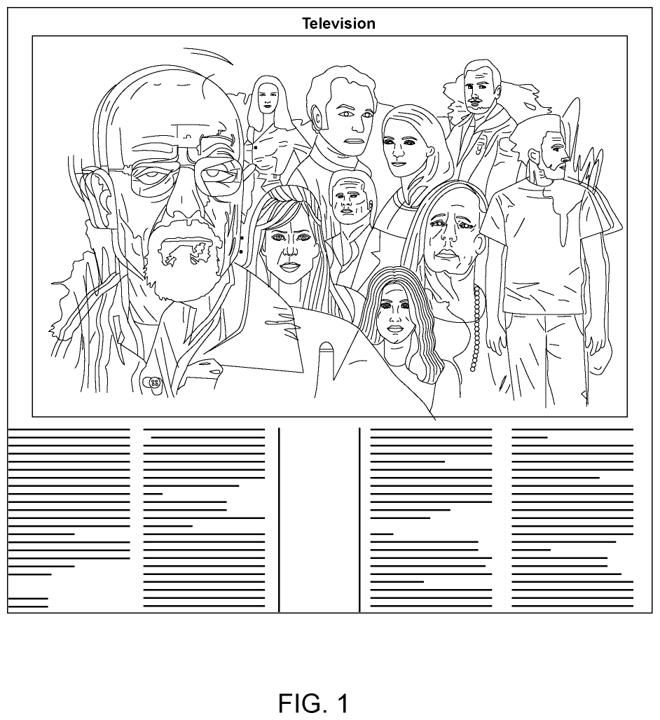

Referring to FIGS. 1, 7, and 11, an initial material having an image on the front thereof to be processed may be a common newspaper print or magazine exhibiting an interesting photo, a copy of an oil painting, a sketch, a caricature drawing, etc. As shown in FIG. 1, the user has drawn lines and/or curves around the image on the source material lines in step 110 using a writing instrument 210, for example, a pencil, a pen, a marker, or other known drawing tools, such as a plotter.

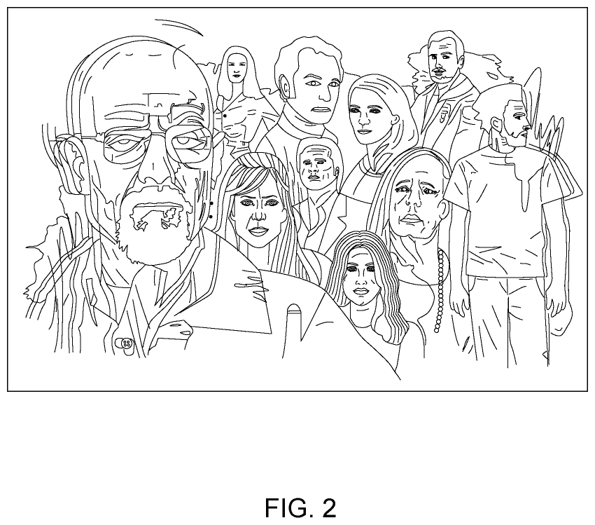

Referring to FIG. 2, the delineated image is cut out from the source material in step 120 by, for example, scissors 220 or a knife.

A spray adhesive is provided in the spray can 230. The spray adhesive may be composed of isohexane, dimethyl ether, acetone, cyclohexane, isobutane, ethane, 1,1-difloro, propane, and N-pentane, or other known spray adhesive substances. Commercial examples of the spray adhesive include ALEENE'S FAST GRAB TACKY SPRAY, 3M SPRA-MENT, SCOTCH SUPER 77, KRYLON SPRAY ADHESIVE, and ELMER'S SPRAY ADHESIVE.

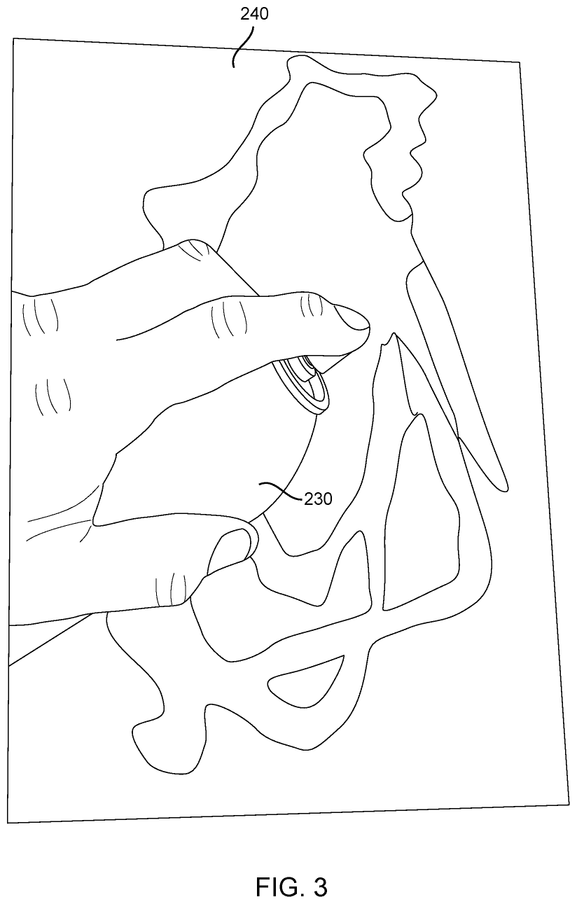

Referring to FIG. 3, the spray adhesive is applied to the construction paper 240 in step 130, for example, by first vigorously shaking the spray can 230, holding the spray can 230 about 6 inches to about 8 inches from the black construction paper 240, and depressing the dispensing button on the top of the spray can 230. A side-to-side motion of the spray can 230 during spraying may be used to evenly apply the spray adhesive to the black construction paper 240.

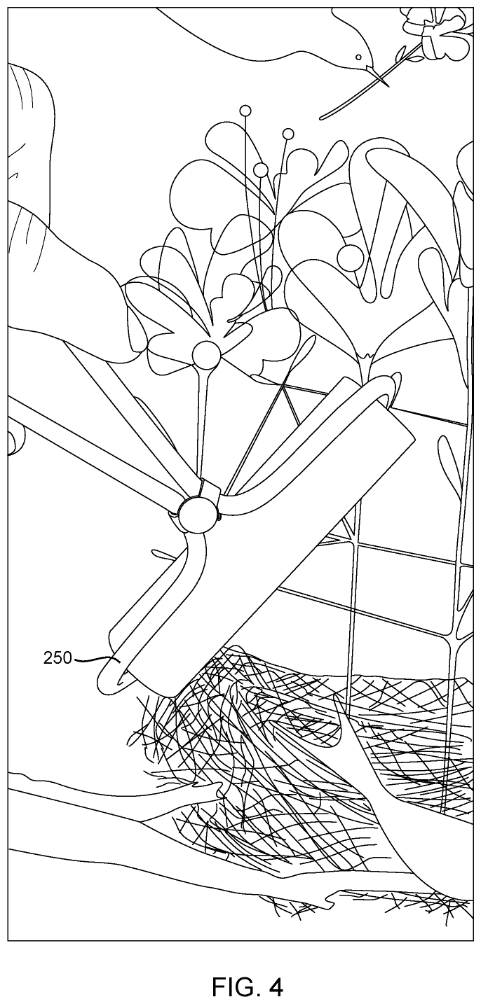

Referring to FIG. 4, with the black construction paper 240 having spray adhesive applied thereto, the image is mounted to a dark background material in step 140, by pressing the rear side against the dark background material, which may be black or dark construction paper 240. The roller 250 is used for mounting the image and smoothening the image in step 150 by vigorously pressing the front of the image against the dark background material 240. This step 150 prevents bubble formation on the surface of the newsprint.

The dark background material 240 aids in concealing any print on the underside of the image. In this embodiment, the roller 250 is constructed of hard rubber. Other types of rollers may be used. The size of the roller is variable, and different sizes and material configurations are available to help place pressure on the newsprint so that it adheres to the black construction paper 240. Such vigorous pressing by the roller 250 prevents bubble formation underneath the image between the rear side and the dark background material. Other devices may be used besides the roller 250 to apply pressure and to prevent bubble formation. For example, a paintbrush can be used as well.

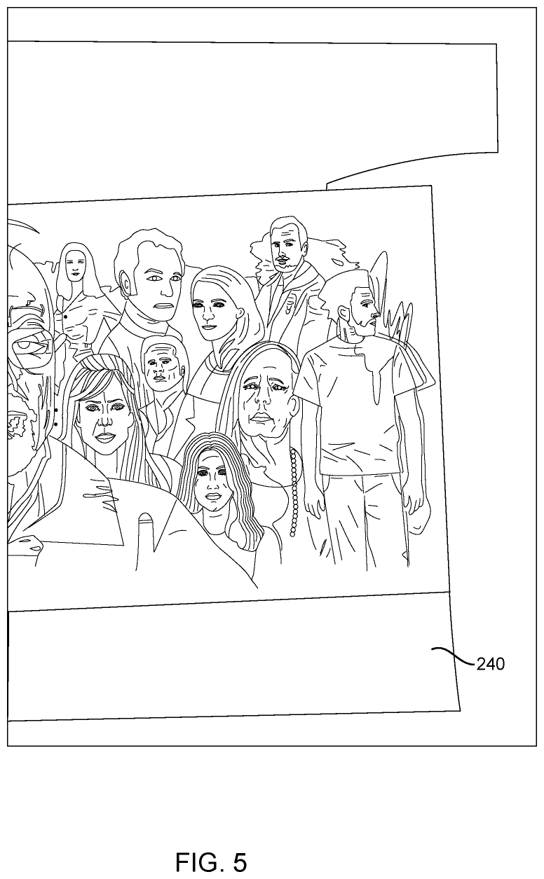

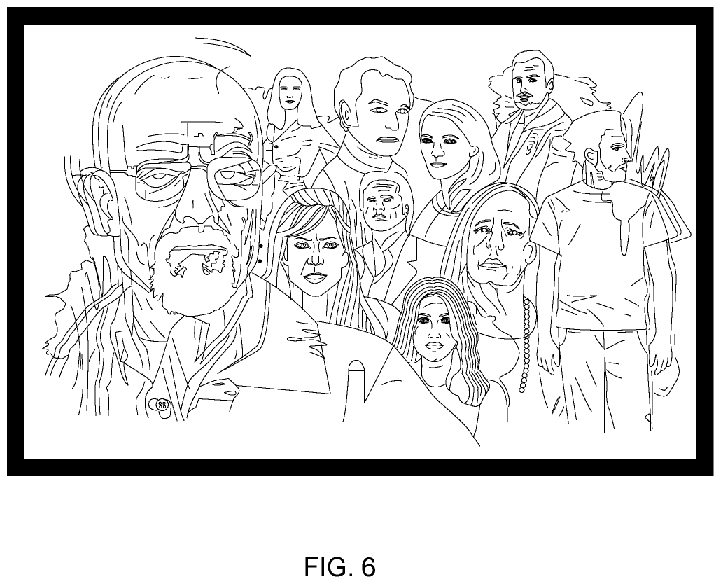

Referring to FIG. 5, after the spray adhesive has set, for example, after 30 minutes, the image will have a portion of the background material 240 surrounding the periphery of the image. The image is optionally trimmed away from the surrounding background material 240 in step 160, for example, by scissors 220 or a knife, to create a trimmed image within the original drawn lines, as shown in FIG. 6, and having only a portion of the dark background on the rear side. Alternatively, the background material 240 may be totally retained with the image mounted thereto, with the surrounding background material functioning as the matte 280 which may be framed in the frame 270.

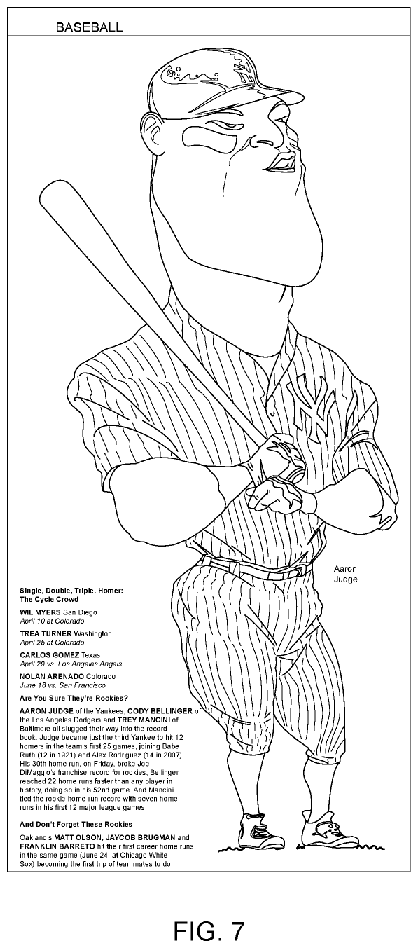

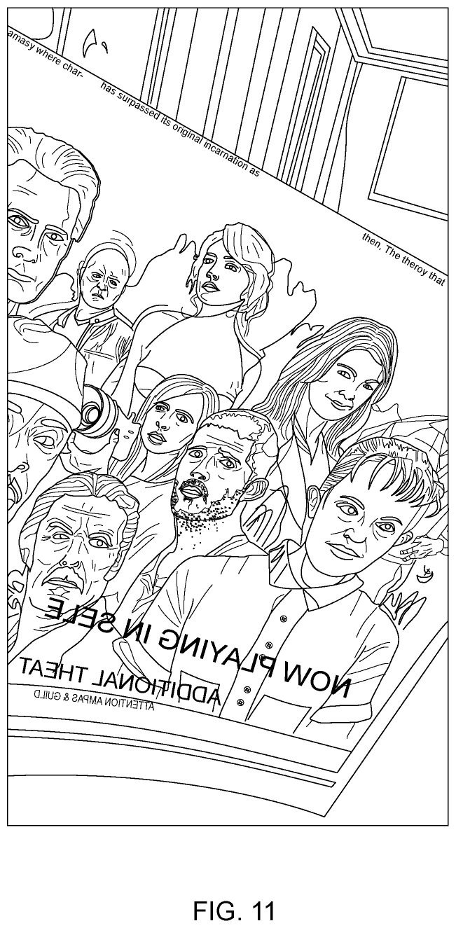

In certain instances, the image may contain unwanted print due to the image having been cut from a source material, such as a newspaper with accompanying print. The image may have been cut to a desired size in step 120 (FIG. 10), as shown in FIGS. 7 and 11, with the unwanted print included within the border and within the desired size of the image. As such, in step 170 (FIG. 10), the user applies ink to the unwanted print so that a consistent background is maintained within the border of the image.

A non-alcohol-based fluid acrylic ink or paint, applied from a dispenser 260, is used in the present invention for applying to unwanted print on the image. Such non-alcohol acrylic ink is necessary and is produced by, for example, an acrylic polymer dispersion manufacturing process. The non-alcohol acrylic paint could be of any color but is preferably a color substantially similar to the original background color of the image. Commercial examples of the acrylic paint include GOLDEN FLUID ACRYLIC, LIQUITEX, BLICK ARTIST'S WATER COLOR, and HOLBEIN AEROFRESH LIQUID ACRYLICS. A commercial example of an acrylic ink is manufactured by HOLBEIN.

Referring to FIGS. 7 and 11, an image having print and/or a sub-image is treated with a thin coating of non-alcohol acrylic ink and a fluid acrylic paint that is selectively applied to hide the selected print or sub-image in step 170. The paint may also function as additional background moderation or used to modify the desired image.

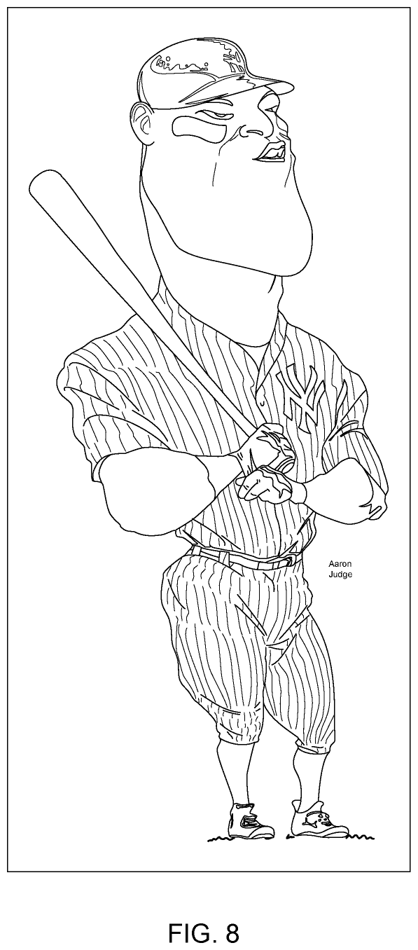

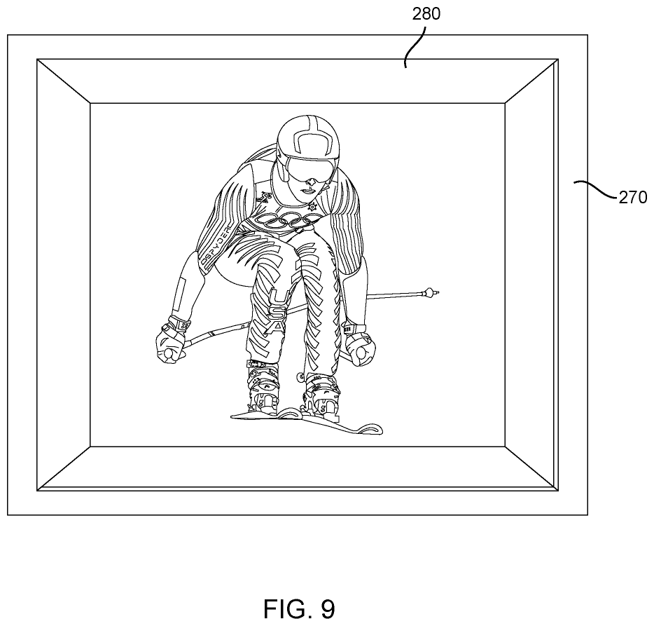

Referring to FIG. 8, the final image is created with the selected print or sub-image having been hidden. Referring to FIG. 9, the final image is mounted in the frame 270 in step 180, which may include the matte 280 surrounding the final image.

The present invention also includes the kit 200 having the black or dark background material 240 composed of, for example, construction paper; the pencil 210; the scissors 220; the spray adhesive; the roller; and non-water-based acrylic ink. Alternatively, instead of the acrylic ink, the kit 200 may include a non-water-based fluid acrylic paint. The kit may optionally include the matte 280 and the frame 270 for mounting and framing the final image created by the method 100 of the present invention.

In alternative embodiments, the present invention includes, after creation of the final image in step 170, the steps of scanning or digitizing the final image, and manipulating the digitized image to be enlarged or reduced in scale or in a selected dimension. In addition, any colors within the image, including black and white colors, can be altered using a variety of digital techniques. Moreover, the digitized image can be further modified, including creating mirror images such as changing a right-looking image into a left-looking image, or slenderizing or expanding the entire image or a selected part of the image. Furthermore, the modified digitized image can then be printed and framed. Additional modifications can be made; for example, the digitized image can undergo further refinement by which the creator of the digitized image can print out the image, and use oils, inks, acrylic paints, or other drawing or painting techniques to further modify the print. With such digital and physical modifications of the created image in step 170, the imagination and skill of the creator of the created image can further create wonderful and aesthetic home art.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

What is claimed is:

1. A kit comprising:
a writing instrument for outlining an image on an image source;
a cutting device for cutting the outlined image from the image source;
an adhesive;
a mounting surface for receiving the adhesive, and for receiving the cut out image on the adhesive; and
a smoothening device for smoothening the received image on the adhesive and on the mounting surface generating a mounted image.

2. The kit of claim 1, wherein the writing instrument is a pencil.

3. The kit of claim 1, wherein the cutting device includes scissors.

4. The kit of claim 1, wherein the adhesive is a spray adhesive output from a spray can.

5. The kit of claim 1, wherein the mounting surface is substantially dark in color.

6. The kit of claim 5, wherein the mounting surface is black.

7. The kit of claim 1, wherein the mounting surface is composed of construction paper.

8. The kit of claim 1, wherein the smoothening device is a roller.

9. The kit of claim 1, further comprising:
a non-water based acrylic substance;
wherein the image includes print; and
wherein the non-water based acrylic substance covers the print.

10. The kit of claim 9, wherein the non-water based acrylic substance is a non-water based acrylic ink.

11. The kit of claim 9, wherein the non-water based acrylic substance is a non-water based acrylic paint.

12. The kit of claim 1, further comprising:
a frame for receiving the mounted image.

13. The kit of claim 12, further comprising:
a matte disposed adjacent to the mounted image on the frame.

14. A method comprising:
outlining an image on an image source using a writing instrument;
cutting the outlined image from the image source using a cutting device;
applying adhesive to a mounting surface;
applying the cut out image on the adhesive; and
smoothening the received image on the adhesive and on the mounting surface using a smoothening device generating a mounted image.

15. The method of claim 14, further comprising:
applying a non-water based acrylic substance to print including in the image to cover the print.

16. The method of claim 14, wherein the non-water based acrylic substance is ink.

17. The method of claim 14, wherein the non-water based acrylic substance is paint.

18. The method of claim 14, further comprising:
mounting the mounting image in a frame.

19. The method of claim 14, further comprising:
mounting the mounting image to a matte.

20. A system comprising:
means for outlining an image on an image source;
means for cutting the outlined image from the image source;
means for applying adhesive to a mounting surface; and
means for smoothening the cut out image placed on the adhesive and on the mounting surface.
